(19) United States
(12) Patent Application Publication
(10) Pub. No.: US 2006/0074795 A1
(43) Pub. Date: Apr. 6, 2006

(54) Super accelerated mortgage and other loan payoff and wealth accumulation

(75) Inventor: Neal Maharaj, Las Vegas, NV (US)

Correspondence Address: HOLLAND & HART LLP, 60 E. SOUTH TEMPLE, SUITE 2000, SALT LAKE CITY, UT, 84111, US

(73) Assignee: Powernet Marketing Systems, Inc.

(21) Appl. No.: 10/955,206

(22) Filed: Sep. 30, 2004

(51) Int. Cl. G06Q 40/00

(52) U.S. Cl. 705/38

(57) ABSTRACT

The present invention describes methods of paying off existing mortgages and other debts at an accelerated pace. The methods include paying an existing mortgage on a simulated bi-weekly or other accelerated schedule without refinancing the existing mortgage. In addition, participants are rewarded with additional principal payments for successful loan referrals of additional participants into the accelerated mortgage or loan payoff methods. When an existing mortgage is paid off, any additional reward points are accumulated and allocated to the participant in a points bank balance for personal use.

### FIELD OF THE INVENTION

The present invention is directed to personal finances, and more particularly, to methods of accelerating mortgage and other debt payoff and wealth creation or accumulation.

### BACKGROUND OF THE INVENTION

The American dream has traditionally encompassed home ownership, largely because owning a home has historically been the best opportunity most families have of creating wealth. In addition to being a sound investment, home ownership means that people have a stake in where they live. Home ownership tends to benefit neighborhoods, as most owners typically improve their property, take pride in their community, and develop deeper roots and higher levels of involvement.

Relatively low interest rates in recent years have contributed to record numbers of homeowners in America. More families own homes with more equity than ever before. Nevertheless, the standard home mortgage takes thirty years or more to pay off. Even at low interest rates, the typical mortgagor will pay one and a half to three times the amount borrowed in interest over the life of the loan.

In an effort to increase equity at a faster rate than traditional mortgages provide, bi-weekly mortgage payment options have been introduced. Traditional mortgage payments are made once a month. However, according to bi-weekly payment plans, instead of making a mortgage payment once a month, mortgagors make half a payment every two weeks. By making half of a traditional monthly mortgage payment every two weeks, homeowners make twenty-six one-half payments a year (fifty-two weeks in a year divided by two). Making twenty-six one-half payments a year results in an extra one-month payment each year (twenty-six one-half payments is equal to thirteen standard monthly payments). The one additional payment every year dramatically reduces the amount of interest paid over the life of the loan. For example, a thirty-year loan of $100,000.00 at 10.5% will have a monthly payment of approximately $914.74 per month, and will be paid off in thirty years. However, if one half of the monthly payment ($457.37) is applied to the same loan every two weeks, the loan will be paid off in twenty years and eleven months, saving one hundred and nine payments or $99,706.66.

Consequently, an increasing number of homeowners have become interested in making their mortgage payments bi-weekly. However, many lenders do not accept bi-weekly payments from their borrowers. Other lenders will not apply bi-weekly payments to customer loans in a timely manner, instead holding the bi-weekly payment in a suspense account or applying it at the end loan term, thus creating no interest savings. Therefore, many borrowers must resort to refinancing and all the expenses and verification processes associated therewith in order to enroll in a bi-weekly program, if their lender offers one. Further, many home owners would prefer to accelerate the payoff of their loans even more than a bi-weekly program will allow, and at the same time increase overall wealth. Therefore, there is a need for better methods and systems of paying off mortgages and increasing wealth without the expense and credit risk of refinancing an existing loan. Conventional debt acceleration programs such as bi-weekly payment plans reduce an average thirty year mortgage by only eight to ten years. To further accelerate debt payoff, principle dollars must come directly from a debtor's own personal funds. However, the discipline required to allocate additional out-of-pocket funds to debt is lacking for most individuals and is not a realistic way to accelerate debt payoff.

The present invention is directed to solving, or at least reducing the effects of, one or more of the problems identified above

### SUMMARY OF THE INVENTION

The present invention meets the above-described needs and others. Specifically, the present invention provides a method of facilitating mortgage or other loan payoff acceleration, comprising finding a participant with an existing mortgage or other loan, arranging the participant's existing mortgage or other loan to be simulated on a bi-weekly schedule for an enrollment fee, allocating reward points to the participant for each loan referral given by the participant that results in payment of a subsequent enrollment fee, allocating options points to the participant for each loan referral given by the participant that results in payment of the subsequent enrollment fee, and splitting the options points into a plurality of pools.

According to some aspect of the invention, the reward points are converted into money and applied as extra principal reduction to the existing mortgage or other loan. The participant may be allocated twenty-five reward or any predetermined number of points for each successful direct loan referral. In addition, the participant may be allocated five reward points or any other predetermined number of points for each successful generational loan referral up to at least six generations. The participant may be allocated five reward points for each generational loan referral up to six generations, and ten reward points for each seventh-generation loan referral if the participant has three or fewer direct loan referrals. Funds for additional principal payments may come from an enrollment company's lead generation or advertising budget, rather than the participants pockets, thus increasing a participant's chance for economic success. The participant may be allocated five reward points for each successful generational loan referral up to six generations, ten reward points for each successful seventh-generational loan referral if the participant has three or fewer direct loan referrals, and fifteen reward points for each successful seventh-generation loan referral if the participant has four direct loan referrals. The participant may be allocated five reward points for each successful generational loan referral up to six generations, and twenty-five reward points for each successful seventh-generation loan referral if the participant has five or more direct loan referrals. These incentives for successful personal loan referrals may be adjusted or recalibrated to increase participant motivation.

According to some aspects of the invention, the participant's existing mortgage or other loan payment is collected bi-weekly and full payments are made directly via electronic transfer from a banking entity to a mortgagee of the participant, preferably on the due date of the regular payment.

According to some aspects of the invention, the plurality of pools include a charity fund pool, a rebate pool, a real estate investment pool, and/or an emergency credit line. The emergency credit line may be accessible up to fifty percent for any reason without qualification.

The arrangement for the participant's existing mortgage to be simulated bi-weekly may include collecting one-half of the participant's mortgage or other loan payment every other week and making a full payment, plus any additional principle payments, directly to the mortgagee on or before a scheduled due date of the participant's loan on behalf of the participant when a full payment has been collected from the participant. The arrangement of the participant's existing mortgage to be paid at an accelerated pace, for example as a simulated bi-weekly program, may be done without refinancing the existing mortgage or other loan.

Another aspect of the invention provides a method of debt elimination. The method includes contracting to have a first existing mortgage or other loan simulated in bi-weekly installments in exchange for an enrollment fee, referring additional participants to contract to have additional existing mortgages simulated in bi-weekly installments in exchange for subsequent enrollment fees, and receiving a percentage of the subsequent enrollment fees. The receipt of a percentage of the subsequent enrollment fee may comprise receiving at least a portion of the percentage as an additional principal payment on the first existing mortgage or other loan. The at least a portion of the percentage may comprise at least twenty-five dollars of each subsequent enrollment fee. According to some aspects of the invention, the at least a portion of the percentage comprises at least five dollars of subsequent generational enrollment fees up to at least five generations, and preferably seven generations.

According to some aspects of the invention, the receipt of a percentage of the subsequent enrollment fee comprises receiving a percentage of the subsequent enrollment fee in divided pools. The divided pools may include a charity fund, an emergency line of credit, a real estate investment fund, and a general rebate fund.

Another aspect of the invention provides a method of wealth accumulation. The method includes enrolling a first participant having a first existing mortgage in a simulated bi-weekly payment system for a first enrollment fee, receiving referrals from the first participant for additional participants, enrolling additional participants, each additional participant having an existing mortgage, in the simulated bi-weekly payment system for additional enrollment fees, allocating dollars or points to the first participant for each of the enrolled additional participants referred by the first participant, and applying at least a portion of the dollars or points to the first participant's first existing mortgage. The method may further comprise dividing a portion of the dollars or points into a plurality of option pools.

The method may further include receiving referrals from one or more of the additional participants for generational participants, enrolling the generational participants, each generational participant having an existing mortgage, in the simulated bi-weekly payment system for additional enrollment fees, allocating dollars or points to the first participant and to the one or more additional participants for each of the enrolled generational participants directly referred by the one or more additional participants, and applying at least a portion of the dollars or points to the first participant's first existing mortgage and to the one or more additional participants' mortgage who referred one of the generational participants.

The method may further include financing the first enrollment fee for the first participant or discounting the first enrollment fee for a full cash payment.

Another aspect of the invention provides a method of mortgage payoff super acceleration, comprising finding a participant with an existing mortgage, enrolling the participant's existing mortgage in a simulated bi-weekly payment program, allocating reward points to the participant for each referral given by the participant that results in a subsequent enrollment, converting at least a portion of the reward points into money, and applying the money to the existing mortgage.

Another aspect of the invention provides a program for paying off other debts once mortgages or other large loans are paid off. Another aspect of the invention is creating or accumulating wealth for personal use after debts are paid off.

Another aspect of the invention provides a means for applying loan referral points directly to accelerate payment of existing loans without using the biweekly simulation.

Additional advantages and novel features of the invention will be set forth in the description which follows or may be learned by those skilled in the art through reading these materials or practicing the invention. The advantages of the invention may be achieved through the means recited in the attached claims.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is a partial table illustrating a typical amortized mortgage payment schedule.

FIG. 2 is a table illustrating the amortized mortgage payment schedule of FIG. 1 with an extra payment made in month twelve based on simulated bi-weekly payments according to principles of the present invention.

FIG. 3 is a table illustrating accelerated mortgage payoff schedules based on simulated bi-weekly payments and additional principal payments according principles of the present invention.

FIG. 4 is a table illustrating the application of rewards points or dollars to an existing mortgage based on loan referrals received directly and generationally from a participant according to principles of the present invention.

FIG. 5 is a table illustrating the allocation of options points or dollars to a plurality of pools based on loan referrals received directly and generationally from a participant according to principles of the present invention.

FIG. 6 is a table illustrating the accumulation of reward points or dollars and options points or dollars according to one embodiment of the present invention.

FIG. 7 is an illustration of bank to bank representation enabling simulated bi-weekly mortgage payments on an existing mortgage according to principles of the present invention.

### DETAILED DESCRIPTION OF THE PREFERRED EMBODIMENTS

As mentioned above, home ownership is a nearly universal goal for people in general. The percentage of home owners has grown significantly over the past several years. Nevertheless, average household debt has also significantly increased over the years. One reason for the increase in household debt is the allocation of a significant percentage of household income to conventional mortgage payments over such a long period of time. The high percentage of household income devoted to mortgage payments often leaves very little income available for other expenses.

For example, an average household may have an annual income of $25,000. Over the course of forty years, the aggregate income of the household may total approximately $1,000,000. However, income taxes, social security taxes, medicare taxes, property taxes, and sales taxes may comprise about thirty percent of total household income. Therefore, only $700,000 is available to the household for general spending. The household with an annual income of $25,000 may typically own a home with a $100,000 mortgage. Based on a standard thirty-year mortgage, the household may reasonably expect to pay approximately $300,000 on the $100,000 mortgage. Therefore, only $400,000 is available to the household over forty years. Divided equally, the household may have less than $200 a week for food, gasoline, clothing, utilities, medical expenses, education, insurance, vacation, etc. A result of the high cost of interest associated with the mortgage is often additional, unsecured debt. A debtor may have to go deeper into debt to pay existing debt and hence there is no relief, which lead to financial disaster for many.

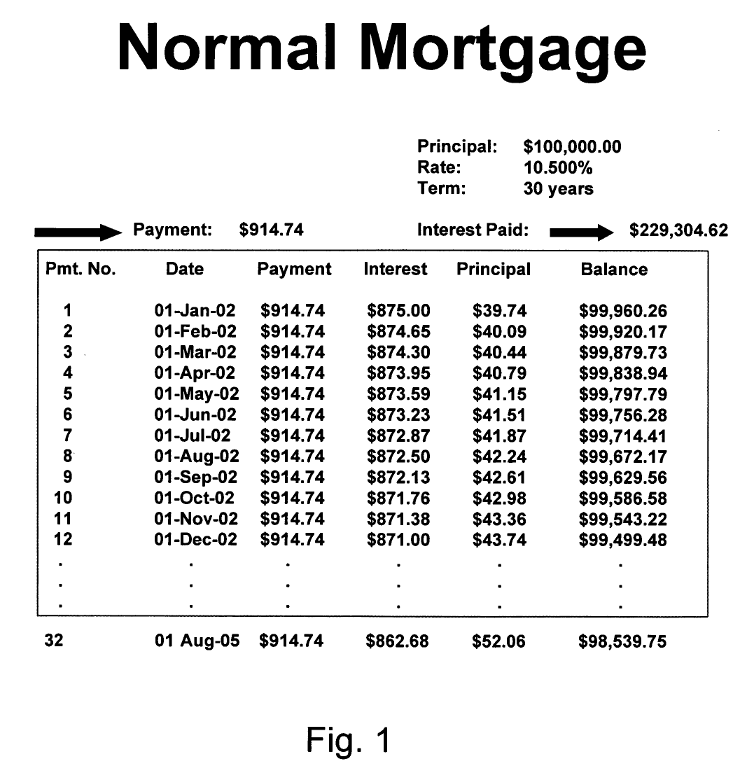

Referring initially to FIG. 1, a partial amortization schedule is shown for a typical thirty year, $100,000.00 mortgage at 10.5% interest for the first thirty-two payments. At a monthly payment of $914.74, the mortgagor pays a total $29,271.68 to the lender for the first thirty-two payments. Of the $29,271.68 paid, only $1460.25 goes to principal reduction. Therefore, for every twenty dollars paid to the lender, only one dollar is applied to the principal. The imbalance works well for the lenders, but is not attractive to the average household.

The early payment of principal to payoff loans at a super accelerated pace without funds coming from the receiving houseowner's pockets is defined herein as a “smart plan.” The act of paying off a loan at a pace greater than a traditional bi-weekly, semi-monthly, or other traditional accelerated payment plan, by adding additional principal payments is defined as “super” accelerated payoff and is therefore distinguished from other traditional accelerated payment plans.

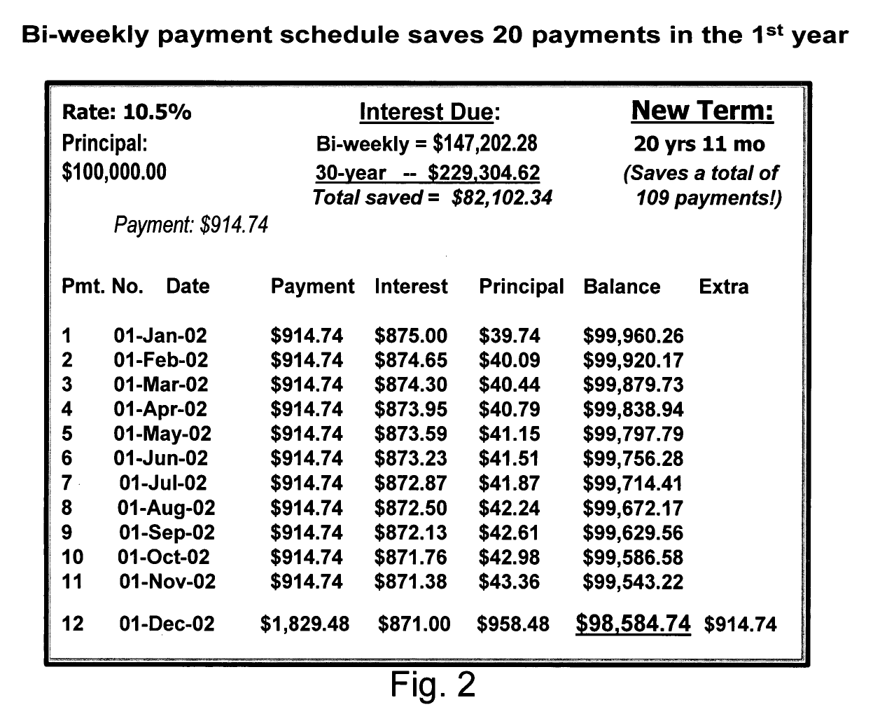

Therefore, according to principles of the present invention, homeowners or participants with an existing mortgage or loan and others are found and contracted to make their mortgage payments on simulated bi-weekly schedule and receive other benefits super accelerating mortgage payoff and building wealth in exchange for an enrollment fee. FIG. 2 illustrates some of the benefits of a simulated bi-weekly mortgage payment schedule. As mentioned above, with a bi-weekly payment schedule, an extra payment is made in month twelve by making twenty-six annual one-half payments. The “extra” $914.74 is applied directly to principal in month twelve as shown in FIG. 2. This one “extra” payment early in the life of the loan will save approximately twenty future payments (or approximately $18,000.00) based on the standard amortization schedule. When an extra principal payment is made, the twenty-to-one debtor's ratio is reversed in the debtor's favor. In essence, the participant saves approximately twenty dollars in interest for each extra dollar paid on principal early in the loan cycle. By continuing to make bi-weekly payments, the term of the thirty year loan will be reduced to twenty years and eleven months. Similarly, every dollar of extra principal reduction payments over and above the biweekly payments further saves twenty dollars, super accelerating loan payoff an shortening the term even more.

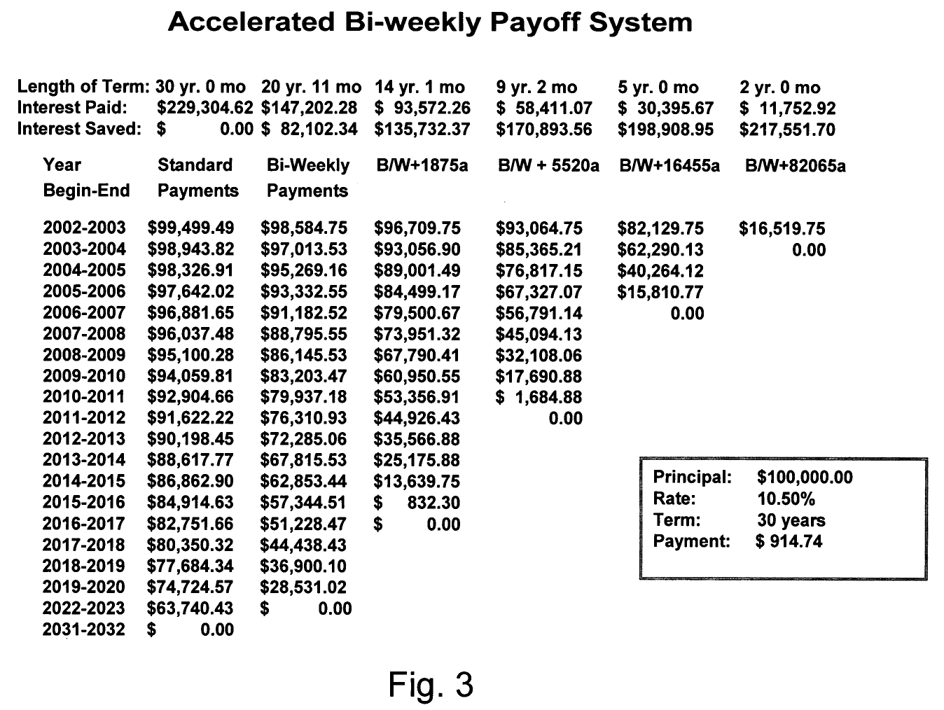

FIG. 3 illustrates the effects of adding additional dollars to principal while making bi-weekly payments. For example, by adding an extra $1875.00 annually, the thirty year mortgage will be paid in fourteen years and one month. Adding an extra $5520.00 annually results in payoff in nine years, two months. An extra $16,455 annually applied to the mortgage yields a payoff in five years. And an extra $82,065 annually applied to the mortgage results in a payoff in only two years. The difficulty, however, is finding the extra money to apply to a participant's mortgage.

According to principles of the present invention, however, reward points are allocated by an enrollment company to a participant with an existing loan for each loan referral given by the participant that results in a subsequent paid enrollment according to a “simulated” bi-weekly mortgage payment schedule. In addition, according to principles of the present invention, it is not necessary to refinance a loan, verify employment, or report any other financial information to participate in the “smart plan” or super accelerated bi-weekly payment plan.

The reward points allocated to the participant for each loan referral provided by the participant that results in a subsequent paid enrollment are converted to dollars and applied directly to principal of the participant's mortgage at no cost to the participant. Therefore, the participant's mortgage term is reduced for each successful loan referral by the allocation of reward points.

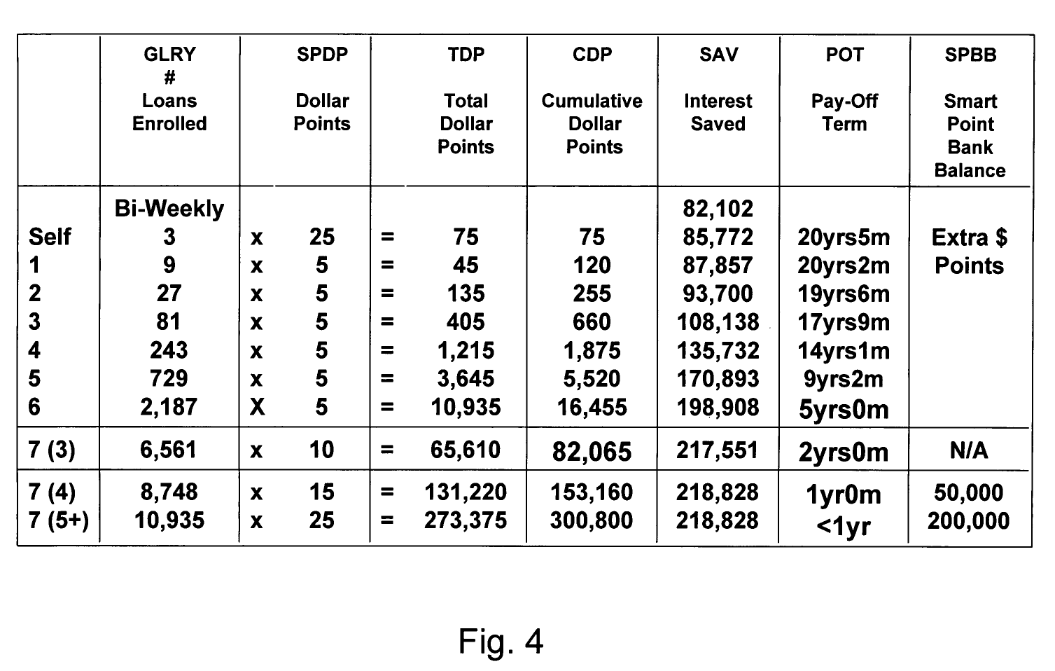

According to one embodiment of the present invention illustrated in FIG. 4, a first participant is allocated a specified number of reward points, for example twenty-five reward points or dollars, for each successful direct “additional loan referral.” A successful loan referral is a loan referral that results in a paid enrollment of a subsequent participant in the simulated bi-weekly payment plan described herein. In addition, the first participant is allocated another specified number of reward points, for example five reward points or dollars, for each “generational loan referral” up to at least five generations, and preferably up to six generations. A first “generational loan referral” means an enrolled subsequent participant referred by one of the direct “additional loan referrals” of the first participant, which may continue to subsequent generations in a manner similar to a family tree.

As shown in FIG. 4, a first participant or “self” finds three successful direct additional loan referrals, and each subsequent generation also finds three successful loan referrals, leading to 6,561 total loans (number of loans, not participant people) at the seventh generation. Some participants may have multiple loans to enroll. FIG. 4 illustrates certain values or percentages of subsequent enrollment fees that may be allocated to participants, however, it will be understood that other values or percentages for direct and generational loan referrals may also be used, and that the numbers described above are exemplary in nature. It will also be understood that each “additional loan referral” and “generational loan referral” begins his or her own new family tree and is compensated with rewards points according to the same system as the first ancestral participant.

The reward points or dollars for each generational loan referral may be allocated differently based on the number of enrolled direct loan referrals supplied by the first participant. For example, as shown in FIG. 4, the first participant may be allocated ten points or dollars for each seventh generational enrolled loan referral if the first participant supplies three or fewer successful direct loan referrals. However, if the first participant supplies four successful direct loan referrals, the first participant may be allocated fifteen points or dollars for each seventh generational enrolled loan referral. The first participant may be allocated twenty-five or more points or dollars for each seventh generational enrolled loan referral if the first participant supplies five or more direct loan referrals. As shown in FIG. 4, as each generational loan referral enrolls, more dollars are applied to the first participant's mortgage, and the pay-off term shortens. Eventually, the participant's mortgage may be paid off and additional points or dollars yield a “Points Bank Balance” that the participant can use for purposes other than mortgage payments. For example the Points Bank Balance may be used for things including, but limited, to, investments such as real estate investments, vehicle purchases, tuition payments, consumer debt payments, bartering for other products and services, etc.

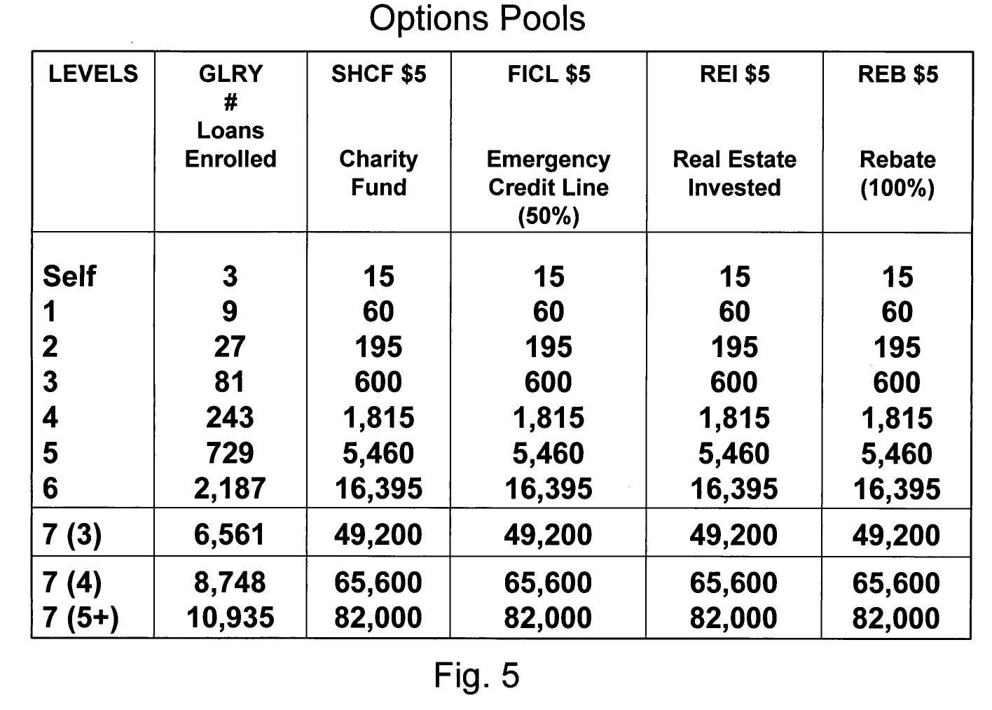

In addition to reward points or dollars, according to some aspects of the present invention the participant may receive options points or dollars for each loan referral as well. Referring to FIG. 5, a chart illustrates one way options points may be divided into a plurality of pools. The options points may be converted to dollars on a 1:1 ratio or some other ratio, or the options points may represent actual dollars.

According to the embodiment illustrated in FIG. 5, the first participant is allocated twenty reward points or dollars for each successful direct additional loan referral. In addition, the first participant is allocated twenty reward points or dollars for each generational loan referral up to at least five generations, and preferably up to seven generations. It will be understood, however, that other values for direct and generational loan referrals may also be used, and that the numbers described above are exemplary in nature.

The options points or dollars for each loan referral may be divided equally or non-equally between a plurality of pools. For example, as shown in FIG. 5, the first participant may be allocated five points or dollars into each of four options pools. The four options pools may include, but are not limited to, a charity fund, an emergency credit line, a real estate investment pool, and a rebate pool. The chart of FIG. 5 illustrates figures up to the seventh generation of loan referrals, and the seventh generation figures are listed for three initial direct loan referrals, four initial direct loan referrals, and five initial direct loan referrals. Each of the pools shown in FIG. 5 is discussed below. It will be understood by those of skill in the art having the benefit of this disclosure that the names of the pools may be changed and still fall within the scope of the invention. The names of the pools indicate a general function, each of which is described below.

The charity fund dollars may be donated to one of a list of preselected charities, or to a charity of the participant's choice. Donations from the charity fund may be made at the request of the participant in the participant's name.

The emergency line of credit is a fund against which the participant may borrow. According to some embodiments, a participant may borrow up to fifty percent of the credit line as a pre-approved loan for emergency reasons. There is no need to qualify or verify employment to access the credit line. The loan from the credit line may be repaid by the participant at a current interest rate.

The real estate investment pool is a fund that may be used to invest in real estate. The enrollment company may have a number of investment opportunities that the participant may allocate some or all of the real estate or other investment pool dollars to. In addition, the participant may also bring an investment prospect to the enrollment company. According to some embodiments, the enrollment company may be at least a fifty percent partner in all real estate investments for supplying negotiations, expertise, management, administration etc. to any real estate investment, whether prospected by the enrollment company or the participant.

Each participant enters a contract with the enrollment company and pays an enrollment fee in exchange for the smart plan or simulated bi-weekly payment program and entry into the rewards and options points program. The rebate pool may be used by the participant as a refund of fees paid to the enrollment company. The fees paid to the enrollment company may include the enrollment contract fee for scheduling simulated bi-weekly mortgage or loan collections, certification fees charged to become associates of the enrollment company, or other fees. According to one aspect of the invention, when a participant reaches an amount in the rebate pool that he or she would like to be refunded, the participant informs the enrollment company that he or she wishes to close the pool and receive the rebate equivalent to the participant's investment. The enrollment company then transfers the dollars in the rebate pool to the participant and closes the rebate pool. The enrollment company may finance the enrollment fee for the participant over time, or the enrollment may discount the enrollment fee for a full up-front payment, however, this is not necessarily so.

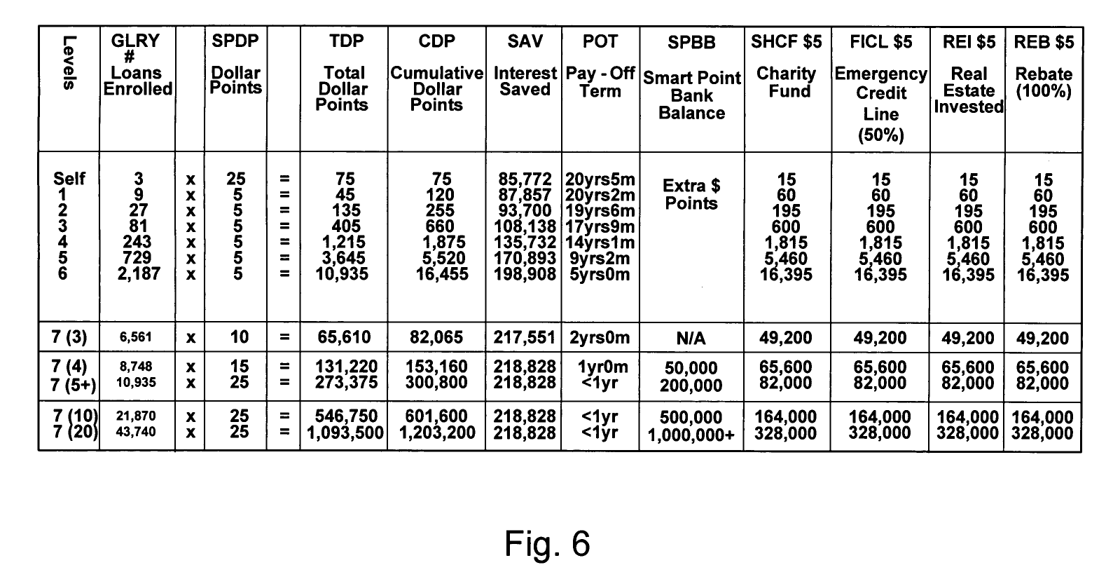

FIG. 6 is a summary of both the rewards points and options points matrices that may be used to reduce debt and increase wealth. The chart of FIG. 6 also shows the results of the rewards and options points if the first participant directly refers ten or even twenty other people who pay an enrollment fee to have their mortgages or other loans payments collect bi-weekly and receive the rewards and options points.

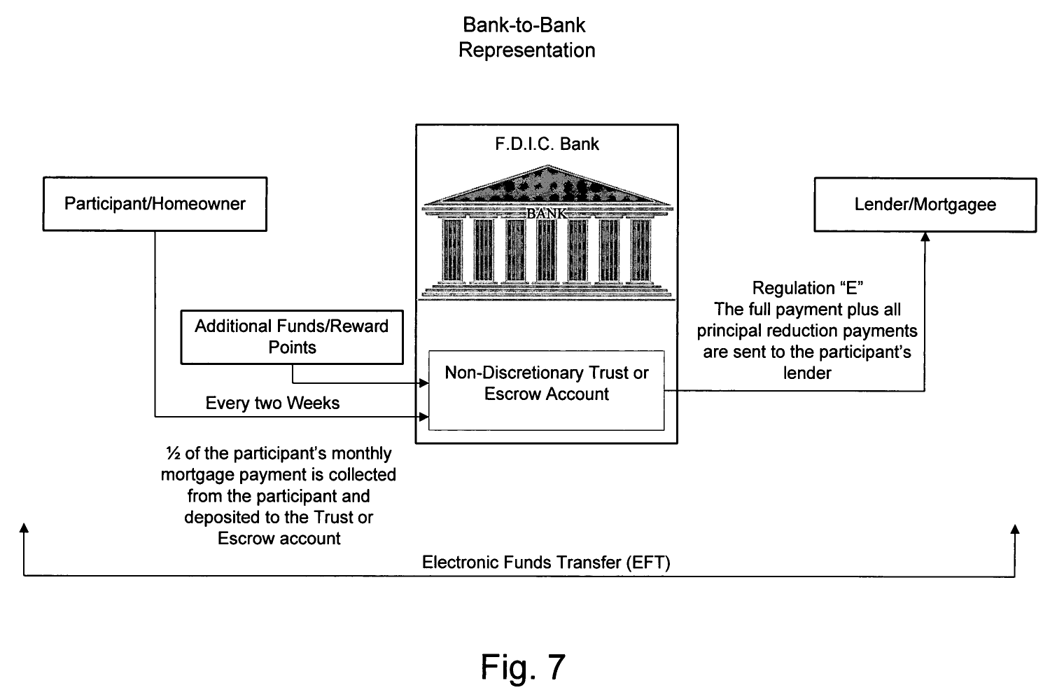

As mentioned above, according to principles of the present invention, the first participant and referred participants may enroll for the smart plan or simulated bi-weekly mortgage payments without refinancing existing loans. However, many existing mortgagees will not accept bi-weekly payments directly from the participant. Therefore, according to principles of the present invention, the enrollment company arranges for an F.D.I.C. bank to act as an intermediary, and the F.D.I.C. bank pays the participant's lender directly via electronic funds transfer (EFT) as shown in FIG. 7. Accordingly, the enrollment company arranges for one-half of a full or monthly mortgage or loan payment to be provided from the participant to a preselected F.D.I.C. bank. Preferably, the one-half payment is withdrawn electronically via an EFT from the participant's bank account. The one-half payment is deposited into a non-discretionary trust or escrow account of the preselected F.D.I.C. bank. The preselected F.D.I.C. bank then waits until a second half (or full payment) is collected. Once a full payment is collected, the F.D.I.C. bank forwards the full payment, plus any additional funds used to reduce principal payment (such as reward points), directly to the participant's lender via EFT on or before the payment due date of the loan. According to the bi-weekly payment collection schedule, once a year an extra full payment is collected and applied to the principal of the participant's loan. Thus, the enrollment company's collection of loan payments from participants on a bi-weekly schedule and making the payments (including the extra payment) to the participant's lender on scheduled due dates constitutes the “simulated” bi-weekly payment schedule or program.

EFTs are currently regulated by government banking rules and regulations. For example, currently bank-to-bank EFTs are applied to a loan or account within a time specified by Regulation E of the regulations promulgated by the Federal Reserve. Accordingly, even if a participant's lender would not normally accept and apply payments on a bi-weekly basis, the use of a preselected F.D.I.C. bank to facilitate bank-to-bank representation “simulates” a bi-weekly mortgage or other loan with funds collected in the escrow account on a biweekly manner. When a couple of one-half payments (equaling a full payment) are received, the full payment is sent to the lender along with any extra principal to super accelerate loan payoff.

It will be understood that participants are not required to be associates of the enrolling company. Participants may refer associates of the enrolling company to potential future participants if they choose, but the participants may not deliver any sales presentations in their roles as participants. Associates make any sales presentations and complete any sales. Nor are any associates of the enrolling company required to participate in the biweekly payment plan. Only associates may receive a commission, override, or bonus from the enrolling company upon a participant enrollment. The participants only receive points as described above, which may be converted to dollars and may thus become taxable. Participants may elect, however, to become associates.

Moreover, participants may receive one or more sources of evidence to verify the application of rewards and options points to their accounts. For example, each time a payment is made to a participant's lender from the preselected F.D.I.C. bank, the participant will presumably receive a statement from the lender showing the payment, including any additional principal payments. In addition, according to some embodiments of the present invention, the enrolling company may provide regular or on demand statements to participants verifying the allocation of rewards and options points to the participant's account. Further, the preselected F.D.I.C. bank and/or a neutral service bureau may also provide a statement to the participant outlining all transactions.

It will also be understood that an existing mortgage or other loan may already be scheduled on an accelerated program such as a bi-weekly or semi-monthly plan. Nevertheless, even accelerated plans may be super accelerated by enrolling in the “smart plan” implementing principles of the present invention. Therefore, an existing loan includes any accelerated loan product.

Further, according to some aspects of the invention, the participant may elect not to make bi-weekly payments to the enrollment company and yet participate in the rewards and options points programs described above. Therefore, according to some embodiments, a participant may refer additional loans for enrollment and receive the rewards points (to be applied to his mortgage or other loan) and options points as well, without entering into a bi-weekly payment system.

The preceding description has been presented only to illustrate and describe the invention. It is not intended to be exhaustive or to limit the invention to any precise form disclosed. Many modifications and variations are possible in light of the above teaching.

The preferred embodiments were chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of facilitating debt payoff super acceleration, comprising:
finding a participant with an existing loan;
arranging the participant's existing loan to be paid according to a simulated bi-weekly schedule for an enrollment fee;
allocating reward points to the participant for each loan referral given by the participant that results in payment of a subsequent enrollment fee;
allocating options points to the participant for each loan referral given by the participant that results in payment of the subsequent enrollment fee;
splitting the options points into a plurality of pools.

2. The method of claim 1, wherein the loan comprises a mortgage.

3. The method of claim 1, wherein the reward points are converted into money and applied to principal of the existing loan.

4. The method of claim 3, wherein the participant is allocated a specified number of reward points for each direct loan referral.

5. The method of claim 4, wherein the specified number is twenty-five.

6. The method of claim 4, wherein the participant is allocated a second specified number of reward points for each generational loan referral up to at least six generations.

7. The method of claim 6, wherein the second specified number is five.

8. The method of claim 4, wherein the participant is allocated a second specified number of reward points for each generational loan referral up to six generations, and a third specified number of reward points for each seventh-generation loan referral.

9. The method of claim 7, wherein the second specified number is five and the third specified number is ten if the participant has three or fewer direct loan referrals.

10. The method of claim 7, wherein the second specified number is five and the third specified number is fifteen if the participant has four direct loan referrals.

11. The method of claim 7, wherein the second specified number is five and the third specified number is twenty five if the participant has five or more direct loan referrals.

12. The method of claim 1, wherein the arranging the participant's existing loan to be paid according to a simulated bi-weekly schedule comprises:
collecting one-half of the participant's loan payment every other week;
making a full payment by a banking entity to a lender via EFT after two one-half payments have been collected together with any additional reward points earned.

13. The method of claim 1, wherein the plurality of pools include a charity fund pool.

14. The method of claim 1, wherein the plurality of pools include a rebate pool.

15. The method of claim 1, wherein the plurality of pools include an investment pool.

16. The method of claim 15, wherein the investment pool comprises a real estate investment pool.

17. The method of claim 1, wherein the plurality of pools include an emergency credit line.

18. The method of claim 17, wherein the emergency credit line is accessible up to 50% for any reason without any qualification.

19. The method of claim 1, wherein the arranging the participant's existing loan to be paid according to a simulated bi-weekly schedule is done without refinancing the existing loan.

20. A method of debt elimination, comprising:
contracting to have a first existing mortgage simulated in bi-weekly installments in exchange for an enrollment fee;
referring additional participants to contract to have additional existing mortgages simulated in bi-weekly installments in exchange for subsequent enrollment fees;
receiving a percentage of the subsequent enrollment fees.

21. The method of claim 20, wherein the receiving a percentage of the subsequent enrollment fees comprises automatically receiving at least a portion of the percentage as an additional principal payment on the first existing mortgage.

22. The method of claim 21, wherein the at least a portion of the percentage comprises at least twenty-five dollars of each subsequent enrollment fee.

23. The method of claim 21, wherein the at least a portion of the percentage comprises at least five dollars of subsequent generational enrollment fees up to at least five generations.

24. The method of claim 20, wherein the receiving a percentage of the subsequent enrollment fee comprises receiving a percentage of the subsequent enrollment fee in divided pools.

25. The method of claim 24, wherein the divided pools comprise a charity fund, an emergency line of credit, a real estate investment fund, and a company rebate fund.

26. A method of wealth accumulation, comprising:
enrolling a first participant having a first existing mortgage in a simulated bi-weekly payment system for a first enrollment fee;
receiving loan referrals from the first participant for additional participants;
enrolling additional participants, each additional participant having an existing mortgage, in the simulated bi-weekly payment system for additional enrollment fees;
allocating dollars or points to the first participant for each of the enrolled additional participants referred by the first participant;
applying at least a portion of the dollars or points to the first participant's first existing mortgage.

27. The method of claim 26, further comprising dividing a portion of the dollars or points into a plurality of option pools.

28. The method of claim 27, wherein the plurality of option pools comprise a charity fund, an emergency line of credit, a real estate investment fund, and a general rebate fund.

29. The method of claim 26, further comprising:
receiving loan referrals from one or more of the additional participants for generational participants;
enrolling the generational participants, each generational participant having an existing mortgage, in the simulated bi-weekly payment system for additional enrollment fees;
allocating dollars or points to the first participant and to the one or more additional participants for each of the enrolled generational participants directly referred by the one or more additional participants;
applying at least a portion of the dollars or points to the first participant's first existing mortgage and to the one or more additional participants' mortgage who referred one of the generational participants.

30. The method of claim 26, further comprising financing the first enrollment fee for the first participant.

31. The method of claim 26, further comprising discounting the first enrollment fee for a full cash payment.

32. A method of mortgage payoff acceleration, comprising:
finding a participant with an existing mortgage;
enrolling the participant's existing mortgage in a simulated bi-weekly payment program;
allocating reward points to the participant for each loan referral given by the participant that results in a subsequent enrollment;
converting at least a portion of the reward points into money;
applying the money to the existing mortgage.

33. The method of claim 32, further comprising:
allocating options points to the participant for each loan referral given by the participant that results in a subsequent enrollment;
splitting the options points into a plurality of pools.

34. The method of claim 32, further comprising:
allowing the participant an option to becoming an associate of an enrollment company;
providing commissions in addition to the reward points to the participant for subsequent enrollments.

35. A method of mortgage payoff acceleration, comprising:
finding a participant with an existing loan;
enrolling the participant in a referral based reward points program;
allocating reward points to the participant for each loan referral given by the participant that results in a subsequent enrollment;
converting at least a portion of the reward points into money;
applying the money to the existing loan.

36. The method of claim 35, further comprising:
allocating options points to the participant for each loan referral given by the participant that results in a subsequent enrollment;
splitting the options points into a plurality of pools.
